(19) United States
(12) Patent Application Publication
(10) Pub. No.: US 2014/0177794 A1
(43) Pub. Date: Jun. 26, 2014

(54) SYSTEM AND METHOD FOR FOCAL SPOT DEFLECTION

(71) Applicants: The Board of Trustees of the Leland Stanford Junior University, (US); GENERAL ELECTRIC COMPANY, Schenectady, NY (US)

(72) Inventors: Bruno Kristiaan Bernard De Man, Clifton Park, NY (US); Kyle Morgan Champley, Walnut Creek, CA (US); Norbert Joseph Pelc, Los Altos, CA (US)

(73) Assignees: The Board of Trustees of the Leland Stanford Junior University, Palo Alto, CA (US); General Electric Company, Schenectady, NY (US)

(21) Appl. No.: 13/726,321

(22) Filed: Dec. 24, 2012

(51) Int. Cl. G01N 23/04

(52) U.S. Cl. CPC G01N 23/04
USPC 378/62

(57) ABSTRACT

An X-ray tube and methods for imaging are disclosed. The X-ray tube includes an emitter configured to generate an electron beam. Further, the X-ray tube includes a target configured to generate X-rays in response to the electron beam, where a target surface includes at least a first region having a first elevation and a second region having a second elevation different from the first elevation. The X-ray tube also includes a detector configured to generate projection data based on the X-rays and a computing device coupled to the emitter, the detector and/or the target. The computing device is configured to deflect a focal spot on the target surface by controlling target rotation such that the electron beam impinges alternatively on the first and second regions. The computing device processes the projection data corresponding to the deflected focal spot positions and reconstructs images of a subject using the processed projection data.

### BACKGROUND

Embodiments of the present disclosure relate generally to diagnostic imaging, and more particularly to systems and methods for producing focal spot deflection for enhanced data acquisition during X-ray imaging.

Non-invasive imaging techniques are widely used in security screening, quality control and medical diagnostic systems. Particularly, in medical imaging, non-invasive imaging techniques such as multi-energy imaging allow for unobtrusive, convenient and fast imaging of underlying tissues and organs. To that end, radiographic imaging systems such as computed tomography (CT) systems, projection X-ray systems and X-ray tomosynthesis systems employ a plurality of radiation sources and detectors.

CT systems, for example, typically include a radiation source and a detector array that may be configured to acquire projection data from different angular positions around a subject. Conventionally, the radiation source includes an X-ray tube, which may further include an anode and a cathode for producing an electron beam that is incident at a focal spot on the anode to generate X-rays. Moreover, repeated incidence of the electron beam at the focal spot may heat the anode to extreme temperatures. Accordingly, the X-ray tube may employ a rotating anode to allow distribution of heat across a larger surface.

Typically, for a single acquisition, the focal spot is located at a constant Y-position and Z-position in a spatial coordinate system corresponding to the X-ray tube. However, certain CT systems are known to use X-ray tubes that employ focal spot deflection (also known as focal spot wobble and/or flying focal spot) for achieving denser data space sampling. By way of example, by intentionally deflecting the focal spot back and forth in the X-direction, which is typically tangential to the anode surface, data samples may be measured at projection lines originating from two different focal spot positions. Controlled focal spot deflection, thus, may allow for acquisition of two or more times the imaging information typically acquired using a stationary focal spot.

Similarly, the focal spot may also be deflected in the Y-direction, which in turn may also cause a deflection of the focal spot in the Z-direction. In one embodiment, the deflection in the Z-direction may cause the focal spot to alternate between two Z-positions in a CT system. Generally, focal spot deflection in the Z-direction results in increased longitudinal sampling density, thereby amplifying high-frequency content in the acquired imaging information, which in turn, improves the Z-resolution. More specifically, the deflection in the Z-direction allows acquisition of two adjacent slices per detector row, for example, obtaining 64 slices for 32 detector rows. The focal spot deflection in the Z-direction, thus, may double a slice capability of the CT system by nominally turning, for example, a 32-slice CT system into a 64-slice CT system.

Conventionally, such focal spot deflections in the X-, Y- and/or Z-directions may be achieved by electrostatic and/or magnetic deflection of the electron beam. Alternatively, focal spot deflection in the X-, Y- and/or Z-directions may be achieved, for example, by alternatingly firing a plurality of electron emitters positioned at slightly offset positions relative to a surface of the anode. Certain other X-ray tube implementations are known to use movement of a patient examination table to achieve increased sampling density in one or more desired directions.

Such conventional approaches for focal spot deflection, however, entail use of additional equipment, for example, additional electrostatic and/or magnetic deflection systems, feedback systems and/or emitters. Furthermore, the conventional focal spot deflection approaches may entail accurate synchronization between the X-ray tube, the detector array and acquisition circuitry in the CT system in real-time for allowing acquisition of accurate imaging data. The conventional approaches, thus, may incur considerable costs and/or may be challenging to implement.

### BRIEF DESCRIPTION

In accordance with certain aspects of the present disclosure, an X-ray tube is disclosed. The X-ray tube includes an emitter configured to generate an electron beam. Further, the X-ray tube includes a target configured to generate X-rays in response to the electron beam impinging on the target, where a target surface includes at least a first region having a first elevation and at least a second region having a second elevation different from the first elevation. Moreover, the X-ray tube includes a detector configured to generate projection data based on the generated X-rays. Additionally, the X-ray tube also includes a computing device coupled to one or more of the emitter, the detector and the target. Particularly, the computing device is configured to deflect a focal spot on the target surface by controlling rotation of the target such that the electron beam impinges alternatively on the at least first region and the at least second region of the target. The computing device is also configured to process the generated projection data corresponding to deflected positions of the focal spot on the target. Further, the computing device is configured to reconstruct one or more images of a subject using the processed projection data.

In accordance with certain other aspects of the present disclosure, a method for imaging is presented. The method includes providing a target in an X-ray tube, where the target includes at least a first region having a first elevation and a second region having a second elevation different from the first elevation. The method further includes deflecting a focal spot on the target by controlling rotation of the target such that an electron beam impinges alternatively on the at least first region and the at least second region. The method also includes acquiring projection data from X-rays emitted in response to the impinging electron beam corresponding to deflected positions of the focal spot on the target. Moreover, the method includes reconstructing one or more images of a subject using the acquired projection data.

In accordance with certain further aspects of the present disclosure, another method for imaging is presented. The method includes directing an electron beam generated by an emitter towards a target in an imaging system. The method further includes acquiring projection data from X-rays emitted in response to the electron beam impinging on the target at deflected positions of a focal spot on the target, where deflection of the focal spot is not synchronized with acquisition of the projection data. The method also includes reconstructing one or more images of a subject using the acquired projection data.

### DRAWINGS

These and other features and aspects of embodiments of the present disclosure will become better understood when the following detailed description is read with reference to the accompanying drawings in which like characters represent like parts throughout the drawings, wherein:

FIG. 1 is a pictorial view of an imaging system for producing focal spot deflection, in accordance with aspects of the present disclosure;

FIG. 2 is a schematic diagram illustrating exemplary components of the imaging system illustrated in FIG. 1, in accordance with aspects of the present disclosure;

FIG. 3 is a schematic representation of a front view of an exemplary shaped anode for use in an X-ray tube in the radiation source of FIGS. 1-2 for producing a focal spot deflection, in accordance with aspects of the present disclosure;

FIG. 4 is a schematic representation of a side view of the shaped anode of FIG. 3 for use in an X-ray tube in the radiation source of FIGS. 1-2, in accordance with aspects of the present disclosure;

FIG. 5 is a diagrammatic illustration of graphical representations that depict certain exemplary positions of a focal spot in the Y- and Z-directions that are deflected using the shaped anode of FIG. 3, in accordance with aspects of the present disclosure;

FIG. 6 is a diagrammatic representation of another exemplary embodiment of a shaped anode, in accordance with aspects of the present disclosure;

FIG. 7 is a diagrammatic representation of yet another exemplary embodiment of a shaped anode, in accordance with aspects of the present disclosure;

FIG. 8 is a graphical representation of a slow focal spot deflection that does not require synchronization with acquisition of projection data, in accordance with aspects of the present disclosure; and

FIG. 9 is a flow chart depicting an exemplary method for imaging a target region of interest using projection data acquired by an imaging system using focal spot deflection, in accordance with aspects of the present disclosure.

### DETAILED DESCRIPTION

The following description presents exemplary systems and methods for producing focal spot deflection for enhanced data acquisition during X-ray imaging. Particularly, embodiments illustrated hereinafter disclose cost-effective imaging systems and methods that provide focal spot deflection using a shaped anode. Certain further embodiments describe systems and methods that allow for slow focal spot deflection. As used herein, the term “slow focal spot deflection” may refer to an implementation where a frequency of the focal spot deflection is less than a frame rate of an associated detector such that, during one detector frame, the focal spot is deflected only by a fraction of a corresponding size of the focal spot size. Alternatively, the term “slow focal spot deflection” may refer to an implementation where the focal spot may be deflected only by a fraction of a peak-to-peak deflection distance during one detector frame, thereby circumventing a need for synchronizing the focal spot deflection with data acquisition by the detector.

Although exemplary embodiments of the present disclosure are described in the context of a CT system, it will be appreciated that use of the present disclosure in various other imaging applications and systems is also contemplated. Some of these systems may include a positron emission tomography CT (PET-CT) scanner, a single and/or multiple source imaging system, a single and/or multiple detector imaging system, a single photon emission computed tomography-CT (SPECT-CT) scanner, an X-ray tomosynthesis system, a magnetic resonance-X-ray (MRX) scanner, an MR-CT scanner and/or any imaging system that uses an X-ray tube.

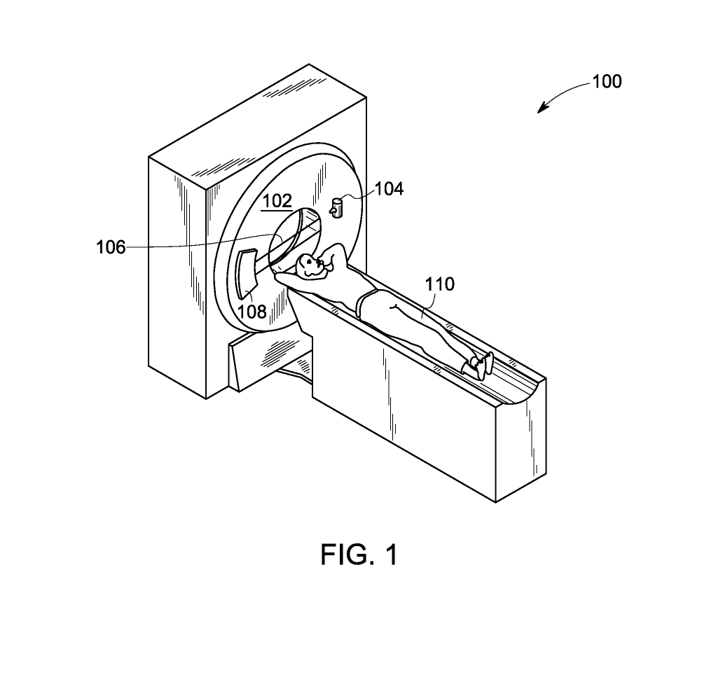

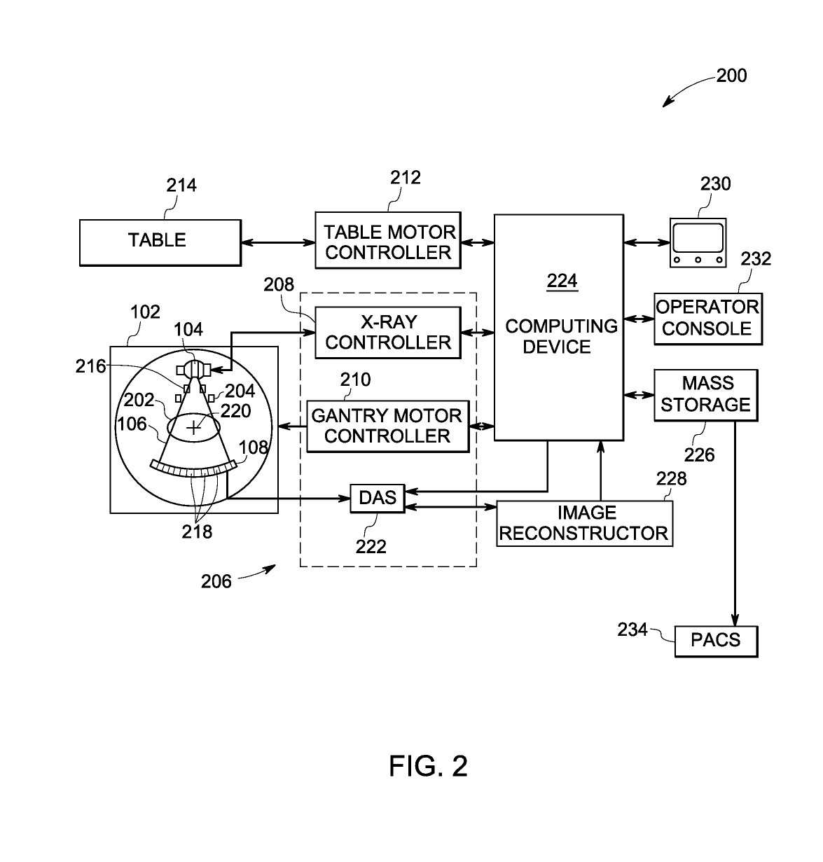

Further, in addition to medical imaging, the methods and systems discussed herein may be applicable in other non-invasive imaging contexts, such as baggage screening, package screening and/or industrial nondestructive evaluation of manufactured parts. An exemplary environment that is suitable for practising various implementations of the present disclosure will be discussed in the following sections with reference to FIGS. 1 and 2.

FIG. 1 illustrates an exemplary imaging system 100 that uses focal spot deflection for acquiring and processing projection data for imaging a subject, such as a patient 110. In one embodiment, the imaging system 100 may correspond to a CT system that may include a gantry 102. In certain embodiments, the system 100 may be configured to acquire projection data, for example, at two or more X-ray energy levels for further display and/or analysis. Moreover, in certain other embodiments, the system 100 may be configured to acquire projection data using a single X-ray source spectrum.

To that end, in one embodiment, the system 100 may include at least one radiation source 104 such as an X-ray tube that may be configured to project a beam of X-ray radiation 106 towards a detector array 108, for example, positioned on the opposite side of the gantry 102. The X-ray tube 104 may include a cathode and an anode (not shown in FIG. 1). In certain embodiments, the cathode may be implemented in the form of an emitter for emitting an electron beam that impinges on the anode to produce X-rays 106. Further, the anode may be configured to serve as a stationary or rotating target for the electron beam generated by the emitter.

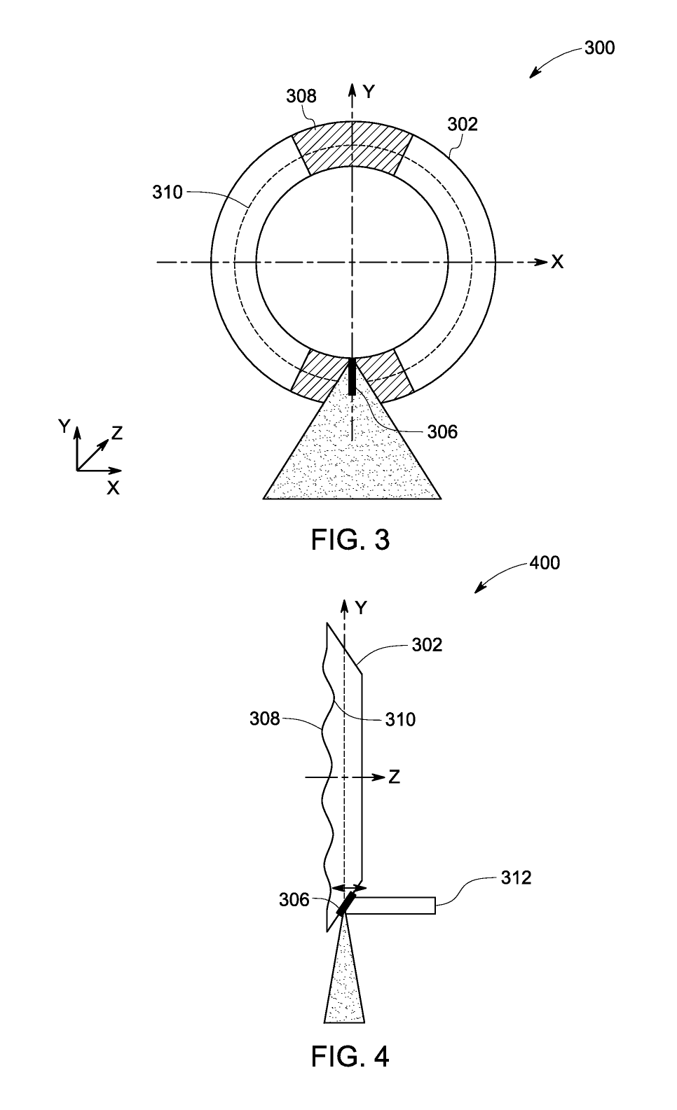

In accordance with exemplary aspects of the present disclosure, in certain embodiments, at least one surface of the anode may include a plurality of regions of varying elevation such that the electron beam impinges alternatively on a first region having a first elevation and a second region having a second elevation different from the first elevation. Particularly, the electron beam impinges alternatively on the first region and the second region to produce a focal spot deflection. However, in alternative embodiments that employ an anode having a planar surface, the radiation source 104 may be configured to electrostatically and/or magnetically deflect the electron beam to produce the focal spot deflection. Certain exemplary embodiments of anodes including a planar surface and a surface having varying levels of elevation for use in producing focal spot deflection will be described in greater detail with reference to FIGS. 3-8.

Particularly, in accordance with exemplary aspects of the present disclosure, the system 100 may employ a slow focal spot deflection in a Z-direction that corresponds to a rotation axis of the anode and/or the system 100. Use of the slow focal spot deflection in the Z-direction may allow the system 100 to acquire sufficient projection data for reconstructing one or more high-resolution images of a region of interest (ROI) using fewer projection views of the system 100. Fewer projection views, in turn, may allow for shorter imaging time and/or a reduction in a radiation dose administered to the patient 110. Certain exemplary configurations of the system 100 that produce focal spot deflection for facilitating enhanced image data acquisition, in accordance with aspects of the present disclosure, will be described in greater detail with reference to FIG. 2.

FIG. 2 illustrates an exemplary embodiment of an imaging system 200, which in certain embodiments, may be similar to the system 100 of FIG. 1. In certain other embodiments, however, the system 200 may differ from the system 100 in the number and/or type of components for imaging a target ROI of a subject 202, such as the medical patient 110 (see FIG. 1) or a baggage. By way of example, in one embodiment, the system 200 may include additional components such as electrostatic and/or magnetic deflection subsystems 204 that may be configured to produce a deflection in an electron beam used for imaging the subject 202. In another embodiment, however, the focal spot deflection may be produced using a shaped anode.

Accordingly, in one embodiment, the radiation source 104 may be configured to project, for example, fan-shaped and/or cone-shaped X-ray beams 106 for imaging the target ROI of the subject 202. In certain other embodiments, the radiation source 104 may be a distributed source configured to emit X-ray beams 106 from multiple locations along a surface. The distributed radiation source 104, for example, may include one or more addressable solid-state emitters configured as one-dimensional or multi-dimensional field emitter arrays. Particularly, the system 200 may be configured to adjust one or more parameters of the emitter arrays to focus the electron beams on the target ROI based on a designated configuration of the detector array 108 and/or a desired method of data acquisition.

Accordingly, in certain embodiments, the system 200 may include a control unit 206 that may be configured to control a rotation of the gantry 102 and/or the operation of the radiation source 104 to acquire projection data from a desired view angle. The control unit 206, for example, may include an X-ray controller 208 that may be configured to provide power and timing signals to the radiation source 104 and a gantry motor controller 210 that may be configured to control a rotational speed and a position of the gantry 102 based on scanning requirements. The control unit 206 may further include a table motor controller 212, which, in turn, may be configured to control a motorized table 214. Particularly, the table motor controller 212 may be configured to move the table 214 for appropriately positioning the subject 202 in the gantry 102 for imaging.

In accordance with certain aspects of the present disclosure, the control unit 206 may be configured to control the radiation source 104 such that the electron beam is incident alternatingly on a first region and a second region of an anode (not shown) in the radiation source 104. In one embodiment, the first and second regions may differ in thickness and/or elevation from each other. Accordingly, the alternating incidence of the electron beam on regions of different thickness and/or elevation may result in movement of the focal spot in a Z-direction relative to a spatial coordinate system of the radiation source 104. Alternatively, the control unit 206 may be configured to provide power and/or timing signals to the electrostatic and/or magnetic deflection subsystems 204 for deflecting the electron beam in the Z-direction for producing the focal spot deflection.

Furthermore, in certain embodiments, the system 200 may include a collimator 216 positioned proximate the radiation source 104 to define the size and shape of the one or more X-ray beams 106 that pass through the target ROI of the subject 202. The collimator 216 may be configured to collimate the X-ray beams 106 based on specific imaging and/or examination requirements using one or more collimating regions, for example, defined using lead or tungsten shutters. In accordance with certain aspects of the present disclosure, the collimator 216 may be modulated, for example, to move in correspondence with the focal spot deflection for collimating the X-ray beams 106. Particularly, the collimator 216 may be configured to confine the X-ray beams 106 to one or more edges of the detector array 108 to maximize dose efficiency.

Particularly, the collimated X-ray beams 106 may pass through the subject 202 and may be attenuated by anatomy of the subject 202. The attenuated portion of the X-ray beams 106 may then impinge on one or more regions of the detector array 108. In one embodiment, the detector array 108 may include a plurality of detector elements 218 that together sense the projected X-ray beams 106 that pass through the subject 202. In certain embodiments, the detector array 108 may be fabricated in a multi-slice configuration to include a plurality of rows of the detector elements 218. In such a configuration, the detector array 108 may include one or more additional rows of the detector elements 218 arranged in a parallel configuration for acquiring projection data for image reconstruction.

To that end, in one embodiment, the detector elements 218 may be configured to produce an electrical signal representative of the intensity of the impinging X-ray beams 106, which in turn, may be used to estimate the attenuation of the X-ray beams 106 as they pass through the subject 202. In another embodiment, the detector elements 218 may be configured to determine a count of photons detected from the X-ray beams 106 and/or to determine corresponding energy. In certain embodiments, the detector array 108 may correspond to a hybrid detector that includes a combination of one or more energy integrating (EI) detector elements 218 and one or more energy discriminating (ED) detector elements 218 arranged in one or more desired configurations for collecting a plurality of radiographic projection views for image construction.

More particularly, during a scan to acquire the projection data, the gantry 102 and the components mounted thereon may be configured to rotate about a center of rotation 220. However, in certain embodiments where a projection angle relative to the imaged subject 202 varies as a function of time, the mounted components may move along a general curve rather than along a segment of a circle. As previously noted, the rotation of the gantry 102 and the operation of the radiation source 104 for acquiring projection data may be controlled by the control unit 206, for example, based on real-time and/or protocol-based inputs.

Furthermore, in certain embodiments, the control unit 206 may further include a data acquisition system (DAS) 222 that may be configured to sample analog data from the detector elements 218 and convert the analog data to digital signals for subsequent processing. Conventional X-ray imaging systems entail accurate synchronization between the radiation source 104, the detector array 108 and the DAS 222 in real-time for allowing acquisition of accurate imaging data using focal spot deflection in each projection view. Such synchronized operation, however, may be mechanically challenging to implement.

Accordingly, unlike such conventional imaging systems, in certain embodiments, the system 200 may allow for a slow focal spot deflection, where the focal spot deflection is not synchronized with the data acquisition. By way of example, in one embodiment, the slow focal spot deflection may have a period of at least four projection views. The slow focal spot deflection, thus, may facilitate a mechanically simple operation of the system 200 for acquisition of projection data. It may be noted that the slow focal spot deflection may allow acquisition of projection data having a quality that is substantially similar to the quality of data acquired through the faster view-to-view focal spot deflection achieved in the conventional imaging systems.

In one embodiment, the data sampled and digitized by the DAS 222 may be input to a computing device 224 for further processing. To that end, the computing device 224 may include, for example, one or more application-specific processors, graphical processing units (GPUs), digital signal processors (DSPs), microcomputers, microcontrollers, Application Specific Integrated Circuits (ASICs) and/or Field Programmable Gate Arrays (FPGAs). Further, the computing device 224 may be configured to store the data in a storage device 226, such as a hard disk drive, a floppy disk drive, a compact disk-read/write (CD-R/W) drive, a Digital Versatile Disc (DVD) drive, a flash drive and/or a solid state storage device.

Additionally, in certain embodiments, the computing device 224 may include modules and/or applications that allow for automated analysis of the acquired projection data. Particularly, in one embodiment, the computing device 224 may employ automated analysis tools, for example, for estimating a phase of rotation of the anode in the radiation source 104 and/or a location of the deflected focal spot directly from the acquired projection data. Alternatively, the computing device 224 may be configured to estimate the focal spot location by reprojecting a preliminary image reconstructed using an assumption of a stationary focal spot.

Accordingly, in certain embodiments, the computing device 224 may be configured to communicate the processed data, for example, including the estimated focal spot location, a peak-to-peak deflection distance of the focal spot and/or the phase of rotation of the anode to an image reconstructor 228. The image reconstructor 228 may be configured to use the received information to reconstruct a high quality image of the target ROI, for example, using iterative image reconstruction. Alternatively, the image reconstructor 228 may be configured to receive projection data that may be re-interpolated to a spatial coordinate system corresponding to an imaging system that does not use focal spot deflection. The image reconstructor 228 may then use the re-interpolated data to generate images of the target ROI, for example, using an analytical or iterative image reconstruction process.

In one embodiment, the image reconstructor 228 may be configured to transmit the reconstructed images to a display 230 that allows an operator to observe the images and other relevant information, for example, using a graphical user interface (GUI). The operator may also specify commands and scanning parameters via an operator console 232, which may include a keyboard (not shown). Although FIG. 2 illustrates only one operator console 232, more than one operator console may be coupled to the system 200, for example, for inputting or outputting system parameters, requesting examinations and/or viewing images. Further, in certain embodiments, the system 200 may be coupled to multiple displays, printers, workstations, and/or similar devices located either locally or remotely, for example, within an institution or hospital, or in an entirely different location via one or more configurable wired and/or wireless networks such as the Internet and virtual private networks.

In one embodiment, the operator console 232 may either include or may be coupled to a picture archiving and communications system (PACS) 234. In an exemplary implementation, the PACS 234 may be further coupled to a remote system such as a radiology department information system, hospital information system and/or to an internal or external network (not shown) to allow operators at different locations to supply commands and parameters and/or gain access to the image data generated using focal spot deflection. Certain exemplary embodiments of the radiation source 104 that employ focal spot deflection for acquiring projection data for use in generating high quality images using fewer projection views, shorter scanning time and/or reduced radiation dose will be described in greater detail with reference to FIGS. 3-6.

FIG. 3, for example, illustrates a diagrammatic representation of an embodiment of an X-ray tube 300 that includes an exemplary shaped anode 302 for producing a focal spot deflection. Particularly, FIG. 3 illustrates a front view of the X-ray tube 300. Further, FIG. 4 illustrates a diagrammatic representation of a side view 400 of the X-ray tube 300. As illustrated in FIGS. 3-4, the shaped anode 302 may include a plurality of regions of varying elevations and/or thickness that cause a focal spot 306 to deflect in a Z-direction corresponding to a rotational axis of an imaging system associated with the X-ray tube 300. In one embodiment, for example, the anode 302 may include a first region 308 having a first elevation and a second region 310 having a second elevation different from the first elevation. Alternatively, the first region 308 may have a first thickness and the second region 310 may have a second thickness different from the first thickness. In certain embodiments, a thickness of the first region 308 having the first elevation may be different from a thickness of the second region 310 having the second elevation. However, in certain other embodiments, the thickness of the first and second regions 308 and 310 may be the same, even though the corresponding elevations of the first and second regions 308 and 310 may be different.

The difference in elevation and/or thickness creates a “hill” region (for example, the first region 308) and a “valley” region (for example, the second region 310) on the anode 302. In one embodiment, the first region 308 and the second region 310 may be created, for example, by selectively depositing a desired material such as tungsten, molybdenum or copper on portions of a surface of the anode 302. In another embodiment, however, the first region 308 and the second region 310 may be created by removing one or more portions of the anode 302 to create alternating hill and valley regions. Further, in certain embodiments, a number of hill and valley regions on the anode 302 may be selected based on a speed of rotation of the anode 302 and/or a data acquisition circuitry, such as the DAS 222 of FIG. 2, associated with the X-ray tube 300. It may be noted that, when using the shaped anode 302, a frequency of the focal spot deflection may vary with the number of hill and valley regions on the anode 302. Accordingly, in one embodiment, the number of hill and valley regions on the anode 302 may be selected to achieve a desired frequency of the focal spot deflection.

Further, in accordance with certain aspects of the present disclosure, the X-ray tube 300 may be configured to operate such that the focal spot 306 moves in the Z-direction as the shaped anode 302 rotates. Particularly, the focal spot deflection in the Z-direction may be achieved even when an electron beam 312 (see FIG. 4) impinging on the anode 302 is stationary in the Y-direction.

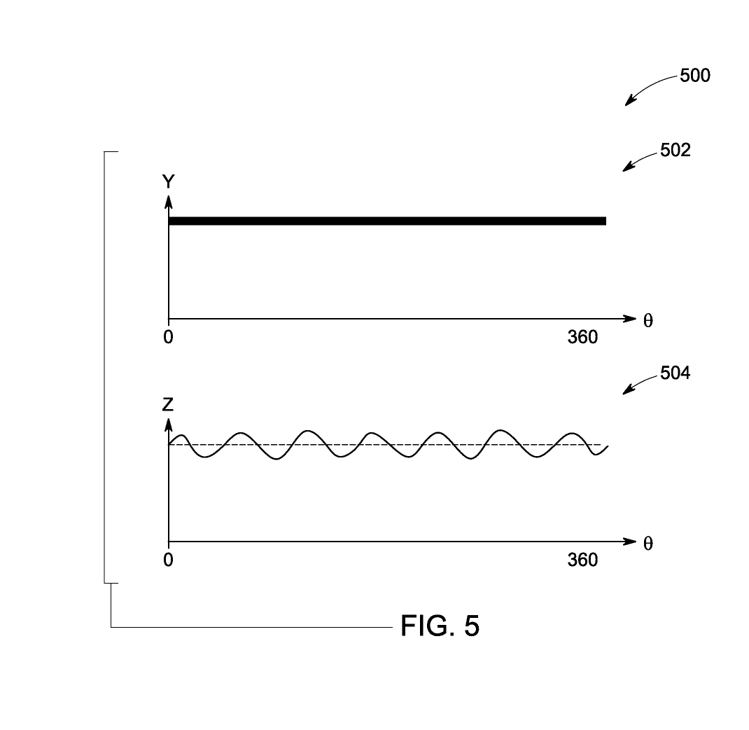

FIG. 5 is a diagrammatic representation 500 of exemplary graphical representations 502 and 504 that depict certain exemplary positions of the focal spot 306 of FIG. 3 that may be deflected in the Y- and Z-directions, respectively. In one embodiment, the Z-direction corresponds to a rotation axis (also referred to as Z-axis) of the anode and/or an associated scanner that includes the anode. Further, the X-direction (also referred to as the X-axis) corresponds to a direction perpendicular to the plane that includes the Z-axis and the focal spot and the Y-direction corresponds to a direction perpendicular to the X-axis and the Z-axis.

As depicted in the graphical representations 502 and 504, use of a shaped anode, such as the shaped anode 302 of FIG. 3 allows for deflection of the focal spot 306 in the Z-direction even in absence of a deflection in the Y-direction. As the focal spot deflection may be achieved with the use of the shaped anode 302, the X-ray tube 300 may allow use of simpler cathode and generator configurations, while still achieving additional data sampling using the deflected focal spot positions. In one embodiment, the additional data sampling achieved using the anode-based focal spot deflection in the Z-direction may aid in reducing aliasing artifacts (typically referred to bear claw artifacts or windmill artifacts).

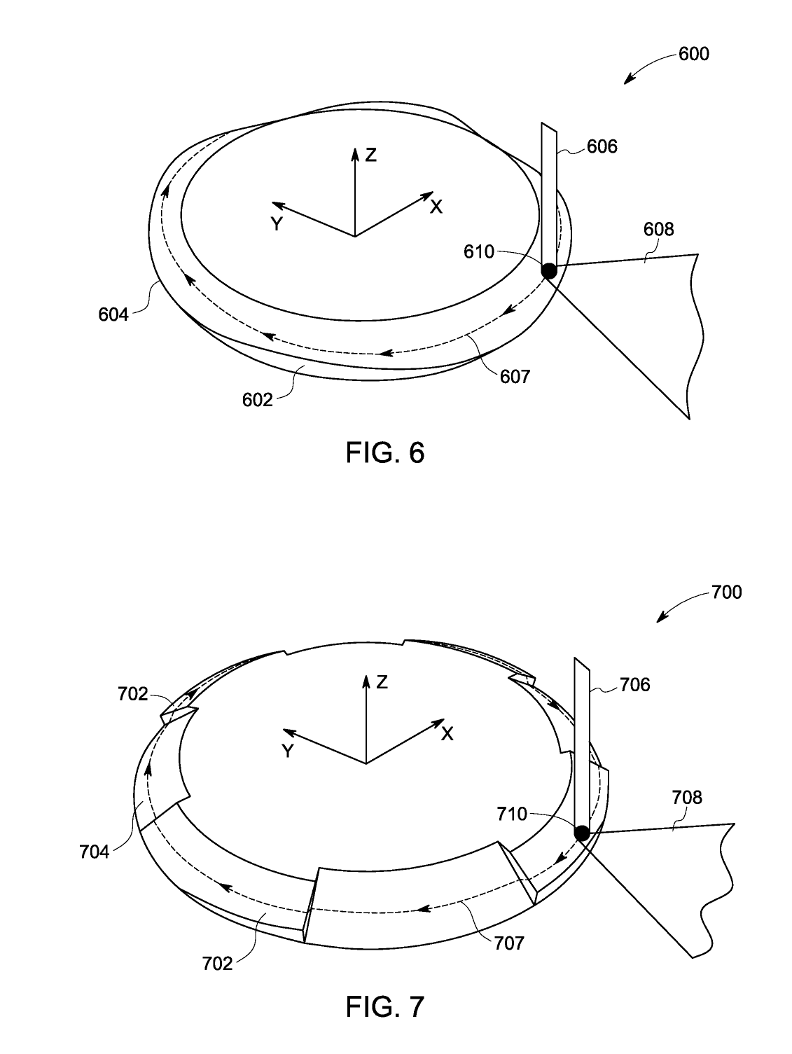

Certain exemplary embodiments of a shaped anode, such as the anode 302 of FIG. 3 for use in producing focal spot deflection are illustrated in FIGS. 6 and 7. Particularly, FIG. 6 illustrates an exemplary embodiment of a shaped anode 600, where an elevation and/or thickness of a plurality of regions over a surface of the anode 600 may vary gradually from a first high Z-region 602 to a second low Z-region 604. As used herein, the term “high Z-region 602” may correspond to a region on the anode 600 that has an elevation that is higher than an elevation of the “low Z-region 604.”

Furthermore, a gradual variation in surface thickness and/or elevation may cause a static electron beam 606 to be incident on different Z-positions on the surface of the rotating anode 600 resulting in emission of an X-ray beam 608. By way of example, the static electron beam 606 may be incident at different Z-positions on the surface of the rotating anode 600 along a focal spot deflection path 607. Incidence of the electron beam 606 on different Z-positions on the surface of the rotating anode 600, thus, may result in a smoother movement of a focal spot 610 in the Z-direction. In one example, the focal spot 610 may be deflected in a sinusoidal fashion in the Z-direction. The sinusoidal movement of the focal spot 610 allows acquisition of a limited number of projection views at the highest and/or the lowest focal spot positions on the anode 600 in the Z-direction. Nevertheless, the projection data acquired using smooth and continuous movements of the focal spot 610 may facilitate slow focal spot Z-deflection without having to synchronize the focal spot deflection with data acquisition by an associated detector. Circumventing a need to synchronize the focal spot deflection with the data acquisition advantageously obviates use of additional control and/or feedback circuitry typically used in imaging systems that employ fast focal spot deflection.

Further, FIG. 7 illustrates another exemplary embodiment of a shaped anode 700. As illustrated in the embodiment depicted in FIG. 7, the shaped anode 700 may include a plurality of regions over a surface of the anode 700 that show a sudden transition from a first region 702 having a high elevation and/or thickness to a second region 704 having a lower elevation and/or thickness as compared to the first region 702. The sharp transition between the first region 702 and the second region 704 may in turn result in a sharp transition of a position of a focal spot 710 in the Z-direction from a high region to a low region. The sharp transitions in elevation and/or thickness of the shaped anode 700 may cause a stationary electron beam 706 to be incident on different Z-positions on the surface of the rotating anode 700 resulting in emission of an X-ray beam 708. Additionally, the sharp transitions in elevation and/or thickness of the shaped anode 700 may also result in a wider focal spot point spread function if the focal spot 710 transitions from the high region to the low region in the middle of a detector measurement frame. Accordingly, an X-ray tube including the shaped anode 700 may be configured such that a resulting deflection of the focal spot 710 along a focal spot deflection path 707 may be representative of a periodic square wave. The focal spot deflection representative of the periodic square wave may allow for acquisition of large number of projection views corresponding to the high and low Z-positions of the focal spot 710 even when using the stationary electron beam 706. The large number of projection views, in turn, may aid in providing accurate projection data for image reconstruction.

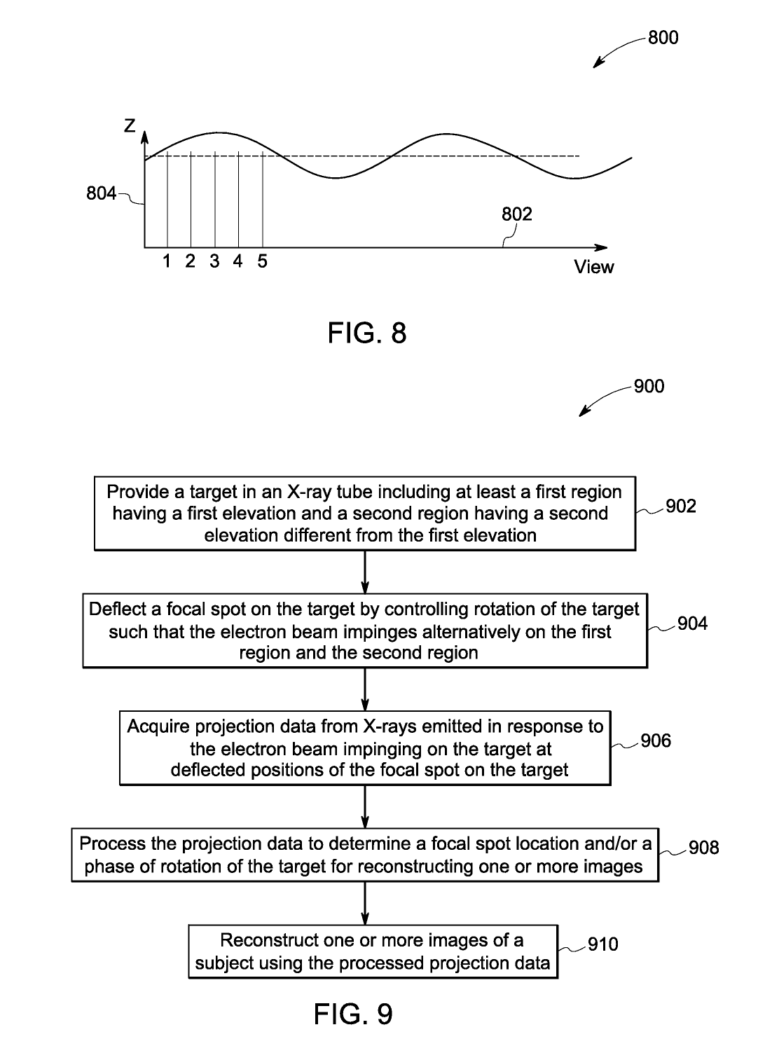

As previously noted, in certain embodiments, a frequency of the focal spot deflection may be determined by a rotation speed of the anode. Accordingly, certain aspects of the present disclosure may allow use of slow focal spot deflection for imaging. By way of example, FIG. 8 illustrates an exemplary graphical representation 800 indicative of a focal spot deflection, where a frequency of the focal spot deflection in a Z-direction is less than a detector frame rate. In the graphical representation 800, a number of projection views or detector frames corresponding to data acquisition are plotted along a first axis 802, while focal spot positions in a Z-direction are plotted along a second axis 804. Although the graphical representation 800 depicts the focal spot deflection as a sinusoidal wave, in certain embodiments, the X-ray tube may be configured to produce a focal spot deflection that may be represented as a periodic square wave for acquiring a larger number of views at the highest and lowest focal spot positions on the anode.

Further, as depicted in the graphical representation 800, in one embodiment, the focal spot may move from a high Z-position to a low Z-position over a determined period, for example, of at least four projection views or detector frames. During the slower focal spot deflection, an average focal spot position may remain substantially similar over the four detector frames, which may result in a reduction in motion blurring in images. Additionally, certain aspects of the present disclosure aid in circumventing a need for synchronizing such a slower focal spot deflection with acquisition of the projection data, and thus, may obviate a need for additional control and/or feedback circuitry used in systems that employ fast focal spot deflection. Accordingly, the slower focal spot deflection may provide for more cost-effective imaging systems, while continuing to provide additional data sampling for use in reducing artifacts and improving image resolution.

Although the focal spot locations need not be synchronized with the detector frames, in certain embodiments, it may be desirable to monitor and/or determine the focal spot locations for use in image reconstruction. Particularly, in one embodiment, the location of the focal spot may be monitored using, for example, an optical sensor and/or a point of reference. In another embodiment, the focal spot location may be estimated by tracking a projection of a reference object positioned in front of one or more reference detector channels. Alternatively, the focal spot location may be estimated directly from the projection data and/or a preliminary image reconstructed using the projection data. The estimated focal spot location may then be used for reconstructing images of a desired region of a patient. Certain exemplary methods for imaging a target ROI of a subject using focal spot deflection will be described in greater detail with reference to FIG. 9.

FIG. 9 illustrates a flow chart 900 depicting an exemplary method for imaging a target ROI using projection data acquired by an imaging system using focal spot deflection. The exemplary method may be described in a general context of computer executable instructions on a computing system or a processor. Generally, computer executable instructions may include routines, programs, objects, components, data structures, procedures, modules, functions, and the like that perform particular functions or implement particular abstract data types. The exemplary method may also be practised in a distributed computing environment where optimization functions are performed by remote processing devices that are linked through a wired and/or wireless communication network. In the distributed computing environment, the computer executable instructions may be located in both local and remote computer storage media, including memory storage devices.

Further, in FIG. 9, the exemplary method is illustrated as a collection of blocks in a logical flow chart, which represents operations that may be implemented in hardware, software, or a combination thereof. The various operations are depicted in the blocks to illustrate the functions that may be performed, for example, during focal spot deflection, projection data acquisition and/or image reconstruction phases of the exemplary method. In the context of software, the blocks represent computer instructions that, when executed by one or more processing subsystems, may perform the recited operations.

The order in which the exemplary method is described is not intended to be construed as a limitation, and any number of the described blocks may be combined in any order to implement the exemplary method disclosed herein, or an equivalent alternative method. Additionally, certain blocks may be deleted from the exemplary method or augmented by additional blocks with added functionality without departing from the spirit and scope of the subject matter described herein. For discussion purposes, the exemplary method will be described with reference to the elements of FIGS. 2-8.

As previously noted, focal spot deflection may allow for denser data space sampling. Particularly, the focal spot deflection in a Z-direction corresponding to a rotational axis of an imaging system may allow acquisition of adjacent slices per detector row, thus, enhancing the imaging capability of the imaging system. Conventionally, focal spot deflection may be achieved using multiple filaments, electrostatic and/or magnetic deflection of the electron beam and/or table movements. Such conventional approaches, however, entail use of additional equipment and/or accurate synchronization between the X-ray tube, detector and acquisition circuitry in real-time for allowing acquisition of accurate imaging data. Consequently, the conventional approaches may incur considerable costs and/or complicated implementation.

Accordingly, embodiments of the present method allow for an imaging method that produces focal spot deflection, for example, using a shaped anode, thereby circumventing the need for conventional beam deflection equipment and/or circuitry. The resulting focal spot deflection aids in acquiring additional projection data for reconstructing high quality images of a subject such as the patient 110 of FIG. 1 for use in diagnosis and/or treatment.

To that end, at step 902, a target such as the shaped anode 302 of FIG. 3 is provided in an X-ray tube for use in imaging a target ROI of the patient. To that end, the target (hereinafter referred to as anode or shaped anode) may include at least a first region having a first elevation and at least a second region having a second elevation different from the first elevation. Particularly, in certain embodiments, the anode may include two or more regions having gradually varying levels of elevations.

Further, at step 904, a position of a focal spot on the shaped anode may be deflected by controlling a rotation of the shaped anode such that an electron beam generated by an emitter in an X-ray tube, such as the X-ray tube 300 of FIG. 3, impinges alternatively on the at least first region and the at least second region of the anode. As previously noted, in accordance with exemplary aspects of the present disclosure, various embodiments of a shaped anode are presented. These shaped anodes include first regions having a first thickness and/or elevation and second regions having a second thickness and/or elevation that are different from the thickness and/or elevation of the first regions.

In a presently contemplated configuration, the first thickness corresponding to the first region having the first elevation may be different from the second thickness of the second region having the second elevation. However, in certain other embodiments, the thickness of the first and second regions may be the same, even though the corresponding first elevation and the second elevation of the first and second regions, respectively, may be different. As previously noted, in one embodiment, a number of regions having the first elevation and the second elevation on a surface of the anode may be selected based on a speed of rotation of the anode and/or a desired data acquisition. In accordance with aspects of the present disclosure, the electron beam incident on the first and the second regions of the anode having different elevations and/or thicknesses may cause the focal spot to deflect in the Z-direction corresponding to a rotational axis of the imaging system. Particularly, by using the shaped anode, the focal spot deflection in the Z-direction may be produced even in absence of a deflection of the electron beam in the Y-direction.

Moreover, in embodiments, where the anode includes more than two regions having varying levels of elevation, the focal spot may be deflected in more than two positions in the Z-direction. Additionally, as previously noted, when using the shaped anode including regions having gradually varying levels of elevation, the focal spot deflection may be represented by a sinusoidal wave. Alternatively, when using the shaped anode including regions having sharp transitions between high Z-regions and low Z-regions, the focal spot deflection may be represented by a periodic square wave.

Additionally, in certain embodiments, the focal spot deflection per view angle may depend on a ratio of a rotational speed of the anode and a view sampling frequency. Accordingly, in one embodiment, the data sampling by the detector frames may be synchronized with the focal spot deflection such that the data is sampled alternatively from the first and second regions. Such synchronization produces a fast focal spot deflection, which may entail use of additional feedback mechanisms for tracking the focal spot position on the anode. However, in certain embodiments, the radiation source may be configured to produce a slower focal spot deflection that need not be synchronized with detector frames. In fact, in an exemplary implementation, use of slower focal spot deflection may be desirable in a large anode to facilitate accurate data acquisition.

Consequent to the electron beam impinging on the shaped anode, X-rays may be emitted by the anode. Subsequently, at step 906, projection data may be acquired from the X-rays emitted in response to the electron beam impinging on the deflected positions of the focal spot on the anode. The projection data may be acquired using a detector, such as the detector array 108 of FIGS. 1-2, corresponding to the imaging system.

To achieve enhanced quality of image reconstruction, a correspondence between the focal spot location and the projection data acquired at the deflected focal spot locations may also be determined. To that end, at step 908, one or more of a focal spot location and a phase of rotation of the anode may be determined for use in the reconstruction of one or more images. In one embodiment, the phase of rotation of the anode may be estimated by analyzing a frequency distribution of the projection data. Particularly, in certain embodiments, the projection data may be analyzed to estimate a phase of rotation of the anode that may minimize a difference between projection data acquired from at least two different projection views. Further, a location of the focal spot may be determined, for example, directly by measuring a rotation angle of the anode using an optical sensor system and a point of reference. In another embodiment, the focal spot location may be determined by tracking a projection of a reference object positioned in front of the detector.

Alternatively, in accordance with aspects of the present disclosure, the location of the focal spot may be estimated directly from the projection data, thus obviating use of any additional reference and/or tracking devices. To that end, in one embodiment, edges of structures of interest in the ROI may be emphasized. In one example, the edges of the structure of interest in the ROI may be enhanced by using a magnitude of a gradient of the projection data for tracking movement of the focal spot location in the Z-direction. Following the focal spot deflection, subsequent projection views may be correlated with each other within a shift along a detector column. Alternatively, the subsequent projection views may be correlated with each other within a shift along the Z-direction corresponding to a shift across detector rows representative of the deflected positions of the focal spot. In one embodiment, this shift may correspond to a correlation distance in the Z-direction between one or more projection views. Accordingly, one or more correlation distances in the Z-direction between the one or more projection views may be determined. The determined correlation distances may then be used to determine a deflection of the focal spot in the Z-direction.

However, the focal spot deflection determined using the determined correlation distances may be confounded with an additional correlation shift due to gantry rotation and table motion. Generally, projection data acquired from centrally located columns of a detector array may allow for more accurate measurement of projection data than columns of the detector located at edges of the detector. Accordingly, it may be desirable to estimate the correlation distances for the detector columns that are positioned proximate to the edges of the detector. The estimation of the correlation distances may allow for estimation of the focal spot deflection in a Z-direction for subsequent projection views. Particularly, in one embodiment, a maximum value of the computed correlations may be used to estimate the focal spot deflection in the Z-direction for the subsequent projection views.

Further, a phase delay corresponding to the subsequent projection views may be estimated. To that end, in one embodiment, conventional signal processing methods may be used to estimate the phase delay between subsequent (but not necessarily adjacent) projection views. The focal spot location may then be determined based on the estimated phase delay. In certain embodiments, for example, the focal spot location may be determined based on a previously determined distribution of the focal spot deflections computed using a determined relationship between a rotational speed of the anode and a particular view angle.

In certain further embodiments, the focal spot location may be estimated using an initial image reconstructed using the acquired projection data with an assumption of a stationary focal spot. The initial image may then be reprojected to acquire reprojected data. Further, a comparison between the acquired projection data and the reprojected data may be used to estimate a shift in location of the focal spot. Alternatively, when using an iterative image reconstruction technique, a peak-to-peak deflection distance of the focal spot, the focal spot location and/or a phase of rotation of the anode may be included as unknown variables and may be estimated with the other reconstruction parameters during various iterations.

Subsequently, at step 910, one or more images of the subject may be reconstructed using the acquired projection data. To that end, in one embodiment, the acquired projection data may be re-interpolated to spatial coordinate positions assuming a stationary focal spot position selected from one or more positions of the deflected focal spot on the anode. The re-interpolated projection data may then be used to reconstruct the images using a desired image reconstruction technique, for example, an analytical and/or an iterative reconstruction technique.

In one embodiment, the imaging system may employ an analytical technique that may entail use of mathematical models and pre-correction of the projection data to mitigate scatter and/or beam hardening artifacts. In another embodiment, the originally acquired projection data may be used for reconstruction. The reconstruction technique, however, may be adjusted, for example, by changing a nature and/or a direction of a reconstruction ramp filter used for processing the projection data for reconstructing the images of the subject. Specifically, the direction of the reconstruction ramp filter may be altered to be tangential to a trajectory of the focal spot, where the focal spot trajectory is defined by a superposition of the gantry rotation and the focal spot deflection. Alternatively, the images may be reconstructed using an iterative image reconstruction technique. Particularly, in one embodiment, an amplitude of peak-to-peak deflection of the focal spot, the focal spot location, the focal spot deflection, scanner geometry and/or a phase of rotation of the anode may be modeled as part of a mathematical model used in the iterative image reconstruction.

Embodiments of the present disclosure, thus, may provide systems and methods for producing focal spot deflection for enhanced data acquisition during X-ray imaging. Particularly, embodiments described herein disclose imaging systems and methods that provide anode-based focal spot deflection for acquiring additional projection data using reduced radiation dose and/or scanning time. Particularly, use of a shaped anode may allow for a cost-effective mechanism for producing the focal spot deflection by obviating use of any additional feedback and/or beam deflection devices. Moreover, use of the shaped anode that includes regions of variable elevation may be easily retrofit to existing imaging systems for improving diagnostic accuracy of the imaging system. Additionally, the focal spot deflection produced using the shaped anode may allow for additional data acquisition for use in reducing artifacts and/or improving image resolution in systems where focal spot deflection would otherwise not be present.

Further, embodiments of the present disclosure have been described with reference to imaging systems that employ shaped anodes and/or slow focal spot deflection in the Z-direction. However, in certain embodiments, use of planar anodes and/or fast focal spot deflection is also contemplated. By way of example, in one embodiment, fast focal spot deflection may be used in imaging systems, such as system 200 of FIG. 2, which employ shaped anodes, such as anodes 600 and 700 of FIGS. 6 and 7, respectively to allow for additional data sampling without using additional electron beam deflection devices. As used herein, the term “fast focal spot deflection” may be used to refer to an implementation where the focal spot is deflected from view-to-view through accurate synchronization of the focal spot deflection with detector frames for acquiring the projection data. Alternatively, in certain embodiments, the imaging system may employ slow focal spot deflection using an electrostatically deflected electron beam impinging on a planar target.

It may be noted that the foregoing examples, configurations and method steps that may be performed by certain components of the present systems, for example, by the control unit 206, the X-ray controller 208, the gantry motor controller 210 and the table motor controller 212 of FIG. 2 may be implemented by suitable code on a processor-based system. Particularly, the steps may be performed using a general-purpose or a special-purpose computer. It may also be noted that different implementations of the present disclosure may perform some or all of the steps described herein in different orders or substantially concurrently, that is, in parallel.

Additionally, the functions may be implemented in a variety of programming languages, including but not limited to Ruby, Hypertext Preprocessor (PHP), Perl, Delphi, Python, Matlab, Freemat, Octave, Interactive Data Language (IDL), FORTRAN, Kuda, C, C++, or Java. Such code may be stored or adapted for storage on one or more tangible, machine-readable media, such as on data repository chips, local or remote hard disks, optical disks (that is, CDs or DVDs), solid-state drives, or other media, which may be accessed by the processor-based system to execute the stored code.

Although specific features of various embodiments of the present disclosure may be shown in and/or described with respect to some drawings and not in others, this is for convenience only. It is to be understood that the described features, structures, and/or characteristics may be combined and/or used interchangeably in any suitable manner in the various embodiments, for example, to construct additional assemblies and techniques for use in producing focal spot deflection for enhanced data acquisition.

While only certain features of the present disclosure have been illustrated and described herein, many modifications and changes will occur to those skilled in the art. It is, therefore, to be understood that the appended claims are intended to cover all such modifications and changes as fall within the true spirit of the invention.

1. An X-ray tube, comprising:
an emitter configured to generate an electron beam;
a target configured to generate X-rays in response to the electron beam impinging on the target, wherein a target surface comprises at least a first region having a first elevation and at least a second region having a second elevation different from the first elevation;
a detector configured to generate projection data based on the generated X-rays;
a computing device coupled to one or more of the emitter, the detector and the target and configured to:
deflect a focal spot on the target surface by controlling rotation of the target such that the electron beam impinges alternatively on the at least first region and the at least second region of the target;
process the generated projection data corresponding to deflected positions of the focal spot on the target; and
reconstruct one or more images of a subject using the processed projection data.

2. The X-ray tube of claim 1, wherein the target comprises a plurality of regions having varying levels of elevation.

3. The X-ray tube of claim 2, wherein the varying levels of elevation are created by selectively depositing material on one or more portions of the target surface, by selectively removing material from one or more portions of the target surface, or a combination thereof.

4. The X-ray tube of claim 1, wherein the first region having the first elevation is thicker than the second region having the second elevation.

5. The X-ray tube of claim 1, further comprising a collimator configured to move in accordance with deflection of the focal spot such that the X-rays are confined to one or more edges of the detector.

6. A method for imaging, comprising:
providing a target in an X-ray tube, wherein the target comprises at least a first region having a first elevation and a second region having a second elevation different from the first elevation;
deflecting a focal spot on the target by controlling rotation of the target such that an electron beam impinges alternatively on the at least first region and the at least second region;
acquiring projection data from X-rays emitted in response to the impinging electron beam corresponding to deflected positions of the focal spot on the target; and
reconstructing one or more images of a subject using the acquired projection data.

7. The method of claim 6, wherein deflecting the focal spot comprises deflecting the focal spot at a frequency based on a number of regions of the target having the first elevation, a number of regions of the target having the second elevation, or a combination thereof.

8. The method of claim 6, deflecting the focal spot comprises deflecting the focal spot at a frequency based on a speed of rotation of the target.

9. The method of claim 6, wherein deflecting the focal spot on the target comprises deflecting the focal spot along a Z-direction corresponding to an axis of rotation of the target.

10. The method of claim 9, wherein deflecting the focal spot on the target comprises deflecting the focal spot along the Z-direction in absence of deflection of the electron beam in a Y-direction corresponding to a direction perpendicular to the Z-direction.

11. The method of claim 6, wherein deflecting the focal spot on the target is not synchronized with acquisition of the projection data.

12. The method of claim 6, further comprising determining one or more of a focal spot peak-to-peak deflection distance, a focal spot location, and a phase of rotation of the target.

13. The method of claim 12, wherein determining the focal spot location comprises:
positioning a reference object adjacent to a detector in an imaging system that comprises the target;
tracking a projection of the reference object on the detector; and
determining the focal spot location based on the projection of the reference object on the detector.

14. The method of claim 12, wherein determining the focal spot location comprises measuring a rotation angle of the target using an optical sensor system.

15. The method of claim 12, wherein determining the focal spot location comprises:
determining one or more correlation distances in a Z-direction between one or more projection views acquired with an imaging system, wherein the imaging system comprises a detector and the target, and wherein the Z-direction corresponds to a rotational axis of the imaging system; and
determining a deflection of the focal spot in the Z-direction using the determined correlation distances.

16. The method of claim 12, wherein determining the focal spot location comprises:
estimating a phase delay corresponding to a plurality of projection views acquired using an imaging system, wherein the imaging system comprises a detector and the target; and
determining the location of the focal spot based on the estimated phase delay.

17. The method of claim 12, further comprising:
identifying a stationary focal spot position from the one or more deflected positions of the focal spot on the target;
reconstructing a preliminary image based on the selected stationary focal spot using the projection data;
reprojecting the preliminary image for acquiring reprojected data; and
determining the deflection of the focal spot in the Z-direction based on a difference between the projection data and the reprojected data.

18. The method of claim 12, wherein determining the phase of rotation of the target comprises analyzing a frequency distribution of the projection data.

19. A method for imaging, comprising:
directing an electron beam generated by an emitter towards a target in an imaging system;
acquiring projection data from X-rays emitted in response to the electron beam impinging on the target at deflected positions of a focal spot on the target, wherein deflection of the focal spot is not synchronized with acquisition of the projection data; and
reconstructing one or more images of a subject using the acquired projection data.

20. The method of claim 19, further comprising electrostatically deflecting the electron beam to deflect the focal spot on the target, wherein the electron beam is deflected at least in a Y-direction to deflect the focal spot in a Z-direction, and wherein the Z-direction corresponds to a rotational axis of the target and the Y-direction corresponds to a direction perpendicular to the Z-direction.

21. The method of claim 19, wherein the deflection of the focal spot is slower than a detector frame rate, and wherein the slow focal spot deflection corresponds to a focal spot deflection with a period of at least four projection views.

22. The method of claim 19, wherein reconstructing the one or more images comprises rebinning the acquired projection data.

23. The method of claim 19, wherein reconstructing the one or more images comprises using an iterative reconstruction algorithm that models the one or more deflected positions of the focal spot.

24. The method of claim 19, wherein reconstructing the one or more images comprises performing a filtered backprojection reconstruction where a direction of a reconstruction filter used in the filtered backprojection reconstruction is altered based on the one or more deflected positions of the focal spot.
